(19) United States
(12) Patent Application Publication
(10) Pub. No.: US 2006/0266469 A1
(43) Pub. Date: Nov. 30, 2006

(54) Apparatus and method for making cellular shade material

(76) Inventor: Fu-Lai Yu, Taipei Hsieh (TW)

Correspondence Address: OLSON & HIERL, LTD., 20 NORTH WACKER DRIVE, 36TH FLOOR, CHICAGO, IL, 60606, US

(21) Appl. No.: 11/136,824

(22) Filed: May 25, 2005

(51) Int. Cl. B32B 37/00

(52) U.S. Cl. 156/264; 156/197; 156/516; 156/556

(57) ABSTRACT

An apparatus and method for making expandable honeycomb structures suitable for use as window coverings is provided. A continuous strip of material is fed to an adhesive applicator and past a cutter. A transverse region that is substantially free of adhesive is created and moved into alignment with the cutter, which is activated to form a cut strip of material with adhesive. The cut strip of material is stacked with similarly formed strip to form the honeycomb structure.

### TECHNICAL FIELD OF THE INVENTION

This invention relates to an improved apparatus and method for making cellular shade material.

### BACKGROUND OF THE INVENTION

One well-known type of window treatment is the honeycomb window shade. A honeycomb window shade is made up of an interconnected series of rows of cells of a thin foldable material suspended from a headrail. There are a variety of apparatus and methods known in the art for manufacturing such honeycomb shades. One method, which is disclosed in U.S. Pat. No. 4,450,027 to Colson, involves folding a continuous strip of fabric into a tube, applying adhesive to the exterior of the tube and then winding the tube onto a rotating rack so that the adjacent windings of the stacked tube are bonded together to form a honeycomb array or stack of cells. The stacked roll of cells is then cut and cellular panels removed from the tube. One problem with such a method is that the cellular panels that are cut from the roll must be trimmed to even out the edges since the array is cut radially from the roll.

Another apparatus and method for making a cellular structure is disclosed in U.S. Pat. No. 5,228,936 and U.S. Pat. No. 5,714,034 to Goodhue. In these patents, a continuous process of applying adhesive to a material having a tubular structure, cutting the strip including adhesive and stacking the cut strips to form a cellular structure is disclosed. One disadvantage with such a process and apparatus is a result of the continuous feeding of material. Since the material is continuously supplied and processed, including the continuous application of adhesive, the process requires the further step of chilling or heating the material after the adhesive has been applied to dry or cure the adhesive. This is done so as to reduce the amount of adhesive residue on components located downstream in the process, such as the cutter and feed rollers. Because the adhesive is cured prior to stacking, the adhesive must be reactivated, such as by heating, to securely bond the stacked strips to one another.

The present invention is an improvement on the described devices and processes for making such honeycomb structures which offers several advantages over the existing art that will be evident to those skilled in the art. Some of these advantages are provided below.

### SUMMARY OF THE INVENTION

A method and apparatus for making an expandable honeycomb structure suitable for a window covering is provided. The honeycomb structure is formed from a continuous ribbon of material, such as fabric, flexible film, laminate, or the like. The continuous ribbon may, prior to the process for forming the honeycomb structure, be processed into a preform. For example, the continuous ribbon may be conveyed to a folder, wherein the folder folds the continuous ribbon of material to form the preform which includes a main portion and at least one marginal portion folded with the main portion. The formation of the preform may also optionally include the additional step of applying at least one line of adhesive to the preform and securing the at least one marginal portion to the main portion. Rather than form the preform in a separate process, the formation of the preform can be incorporated into the process for making the honeycomb structure.

The form of the rows that are eventually constructed may be varied by the folding pattern utilized. This may include single cell or double cell honeycombs, or symmetrical or asymmetrical shaped rows. The preforms may also form partial cells, which when adhered to similarly formed preforms form complete cells.

The preform is conveyed to an adhesive applicator and at least one line of adhesive is applied to the preform. The preform including the adhesive is then conveyed past a cutter. Preferably, this cutter is a guillotine style cutter. The application of the adhesive to the preform is ceased when adhesive has been applied to a desired length of material. The conveyance of the preform is also halted immediately after the adhesive applicator is stopped. As such, a relatively minor transverse region of the preform is defined which does not include adhesive. This transverse region of the preform is conveyed into alignment with the cutter. Preferably, the cutter is located immediately downstream of the adhesive applicator such that when the conveyance of the preform is halted the transverse region of the preform is aligned with the cutter. The cutter is actuated to cut the preform and define a row member. The row member is then conveyed downstream towards a stacker, which receives the row member. The stacker stacks and bonds the row member with other row members. After stacking the row member with other row members, the stacker resets to receive an additional row member. A detailed explanation of a preferred embodiment of the stacking device is provided in U.S. Pat. No. 5,630,900, which is incorporated herein by reference.

Since the stacking device is able to stack only one row member at a time, the stacker stacks a row member and then resets to receive another row member. Accordingly, a time gap must be created between the arrival of subsequent row members. One manner in which such a time gap is created is by resuming the conveyance of the preform only after the stacker resets. Alternatively, an accelerator can be utilized to increase the progress of the row member into the stacker. Other manners of creating the time gap will be apparent to those skilled in the art. For example, it is contemplated that a plurality of stackers can be incorporated into a single process and alternate row members diverted to the stackers. The time gap is thereby formed through the alternating of the stackers.

In another embodiment, rather than feed the entire preform intermittently, only the adhesive applicator is operated in a stop-and-go manner. In this embodiment, the adhesive applicator applied a predetermined length of adhesive to the preform, which is fed continuously. A gap in the line of adhesive is created by stopping the application of adhesive, which also defines the transverse region. A cutter blade then cuts the preform at the transverse region while the preform is in movement. After the preform is cut to define a row member, the row member is accelerated towards the stacker.

Because the process is operated in a stop-and-go or intermittent manner, the adhesive does not need to be dried or cured as is required in the prior art patents discussed above. As such, there is no requirement for additional cooling or heating rollers. Accordingly, the process is more efficient since these additional curing steps are not required. Also, there is no need for the stacked rows to be further heated to reactivate the adhesive for bonding. In other words, with the present invention the row members are bonded as they are stacked. Also, because the cutter operates to cut the preform in an area substantially free of adhesive, the problems of adhesive residue on the cutter are minimized or eliminated.

An optional feature of the present method and apparatus is the partial cutting of the preform. In other words, rather than completely sever the preform when forming the row member, the preform may instead be perforated such that a frangible material strip of material is created. The row member can then be fully separated by accelerating the row member relative to the remainder of the material strip.

### BRIEF DESCRIPTION OF THE DRAWINGS

In the drawings,

FIG. 1 is a schematic side view of one form of an apparatus for performing a method according to the present invention;

FIG. 1A is a close up view of a portion of FIG. 1;

FIG. 2 is a cross-sectional view along the line 2-----2 of FIG. 1;

FIG. 3 is a cross-sectional view along the line 3-----3 of FIG. 1;

FIG. 4 is a cross-sectional view of a tubular preform;

FIG. 5 is a cross-sectional view along the line 5-----5 of FIG. 1;

FIG. 6 is a cross-sectional view along the line 6-----6 of FIG. 1;

FIG. 7 is a perspective view of a window covering including the cellular structure formed according to the method of FIG. 1;

FIG. 8 is a schematic side view of an alternative form of an apparatus for performing a method according to the present invention;

FIG. 9 is a cross-sectional view along the line 9-----9 of FIG. 8;

FIG. 10 is a cross-sectional view along the line 10-----10 of FIG. 8;

FIG. 11 is a cross-sectional view of a tubular preform;

FIG. 12 is a cross-sectional view along the line 12-----12 of FIG. 8;

FIG. 13 is a cross-sectional view along the line 13-----13 of FIG. 8;

FIG. 14 is a perspective view of a window covering including the cellular structure formed according to the method of FIG. 8;

FIG. 15 is a schematic cross-sectional view of an alternative preform folding pattern for the material;

FIG. 15A is a foreshortened schematic cross-sectional view of the preform of FIG. 15 stacked with other similarly constructed preforms;

FIG. 16 is a schematic side view of another alternative embodiment of an apparatus for performing a method according to the present invention;

FIG. 17 is a schematic cross-sectional view of a preform from FIG. 16;

FIG. 18 is a schematic cross-sectional view of an alternative preform from FIG. 16;

FIG. 19 is a schematic side view of another alternative embodiment of an apparatus for performing a method according to the present invention; and

FIG. 19A is a close up view of a portion of FIG. 19.

### DESCRIPTION OF THE PREFERRED EMBODIMENT OF THE INVENTION

The invention disclosed herein is susceptible of embodiment in many different forms. Shown in the drawings and described hereinbelow in detail are preferred embodiments of the invention. It is to be understood, however, that the present disclosure is an exemplification of the principles of the invention and does not limit the invention to the illustrated embodiments.

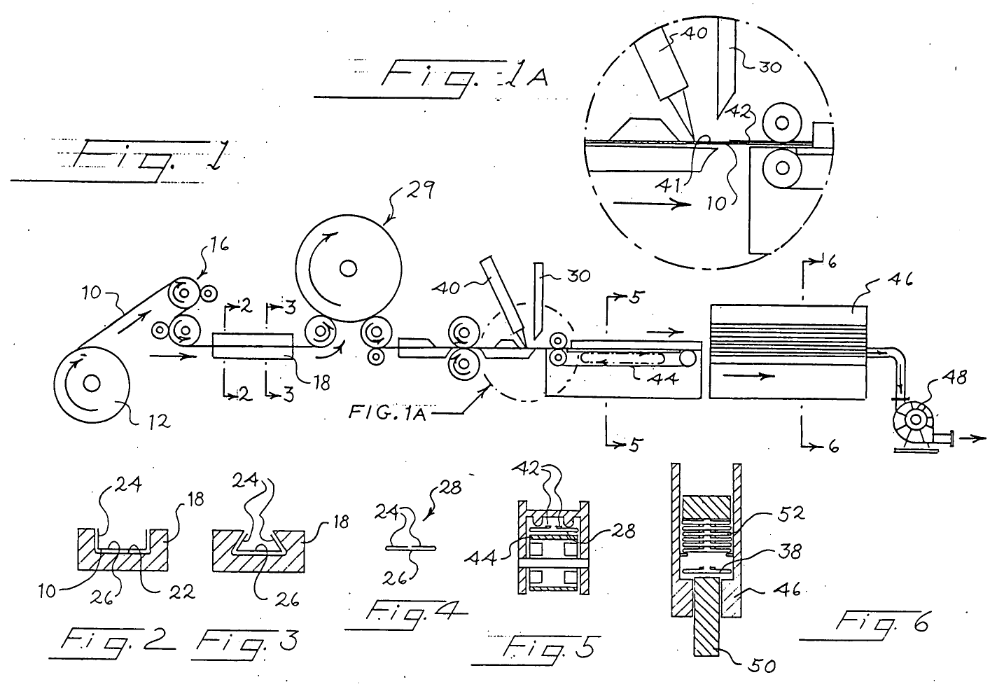

FIGS. 1-6 illustrate a preferred embodiment of the method and apparatus according to the present invention. A continuous ribbon or strip of material 10 is typically provided in the form of a roll 12. A drive mechanism (not shown) is operatively connected to a series of feed rollers 16 that continuously pulls the material 10 off of the roll 12 and conveys the material 10 downstream to a folder 18. The material 10 is folded by the progression of the material 10 through the folder 18 to form a preform. For example, as shown in FIGS. 2 and 3, the material 10 is folded as it passes through channel 22 of folder 18. In FIG. 2, the material is folded such that two opposed marginal portions 24 and a central portion 26 are formed. Referring to FIG. 3, the two marginal portions 24 are folded over the central portion 26 to form a tubular preform 28 (FIG. 4). After folding, the preform 28 includes two marginal portions 24 on top of the central portion 26 as shown in FIG. 4. Another series of rollers 29 which are also preferably operatively connected to the drive, continue feeding the material 10, and in particular preform 28 downstream. Rollers 29 are used to set the creases in the preform 28 through the application of heat.

The preform 28 is guided downstream to an adhesive applicator 40 that applies at least one line of adhesive to the material. In this particular embodiment, a pair of lines of adhesive 42 are deposited as shown in FIG. 5. In this example, the adhesive lines are positioned at the edges of the marginal portions 24.

The preform 28 including the adhesive is then conveyed past a cutter 30, which in this embodiment is a guillotine style cutter. The application of the adhesive to the preform 28 is ceased when adhesive lines 42 have been applied to a desired length of material. The conveyance of the preform 28 is also halted immediately after operation of the adhesive applicator 40 is stopped. As such, a relatively minor transverse region 41 of the preform is defined which does not include adhesive (FIG. 1a). This transverse region 41 of the preform 28 is conveyed into alignment with the cutter 30. As shown, in this embodiment the cutter 30 is located immediately downstream of the adhesive applicator 40 such that when the conveyance of the preform 28 is halted, the transverse region 41 of the preform is aligned with the cutter 30. The cutter 30 is then actuated to cut the preform 28 at the transverse region 41 such that a row member is formed.

For example, row member 38 (FIG. 6) with adhesive lines 42 is supported by a conveyor belt 44 and is transported downstream to stacker 46. As the row member 38 approaches stacker 46, an airflow device, such as a vacuum 48, accelerates the downstream conveyance of the row member 38 into the stacker 46. Referring to FIG. 6, the row member 38 is supported within the stacker on lift member 50, which raises the row member 38 into contact with other similarly formed row members 52 and bonds row member 38 thereto. A detailed explanation of a preferred embodiment of the stacking device 46 is provided in U.S. Pat. No. 5,630,900, which is incorporated herein by reference. Unlike the prior art method and apparatus of U.S. Pat. No. 5,228,936 and U.S. Pat. No. 5,714,034 to Goodhue, there is no need to apply additional pressure and heat to activate the adhesive lines to cause the row members to adhere to one another because the adhesive in the present embodiment of the invention is not dried or cured as required in the prior art. Also, since the transverse region 41 is substantially free of adhesive, adhesive residue on the cutter 30 is prevented.

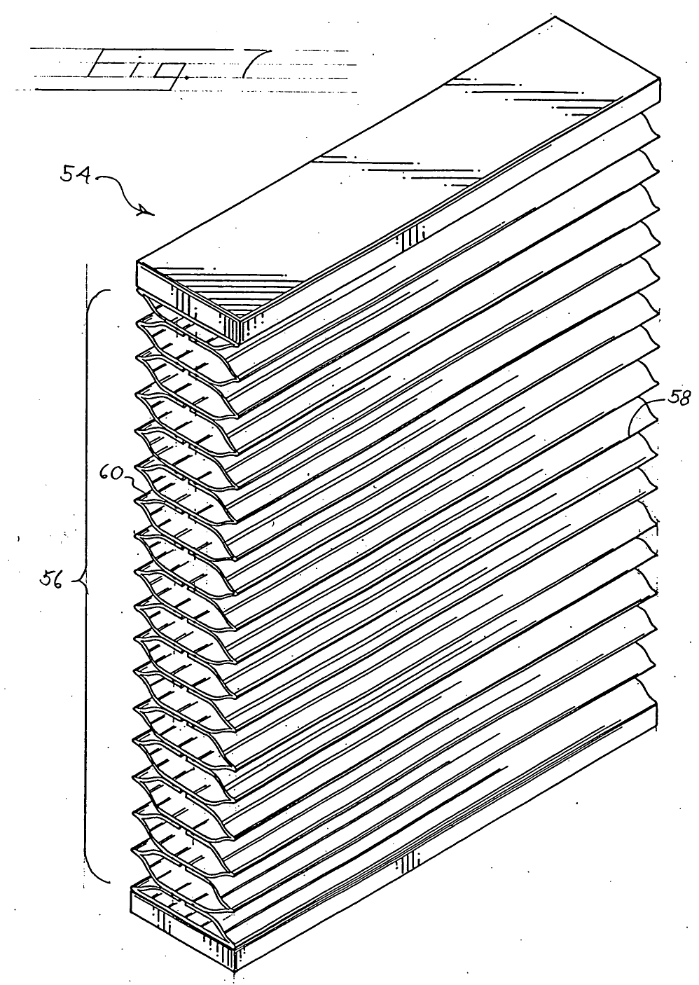

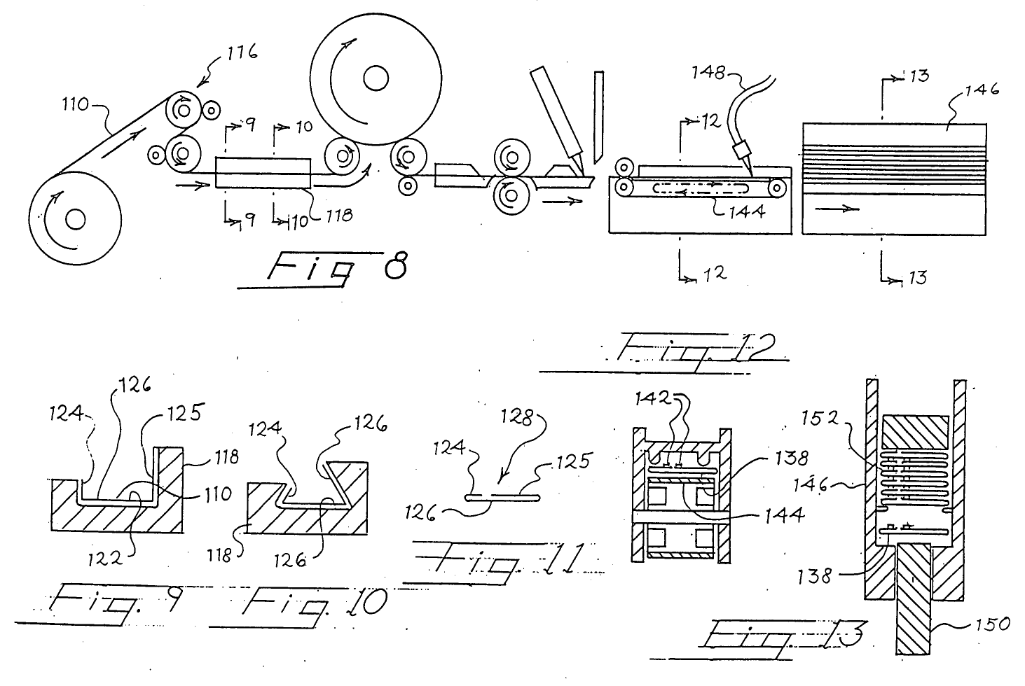

After forming the cellular structure, appropriate control cords and control mechanisms, which are typically found in a head rail, are attached to the cellular structure. A window covering 54 including the cellular structure 56 made according to the method described above is shown in FIG. 7. As shown, the cellular structure 56, when expanded forms a single column of cells having a symmetrical face 58 and rear 60.

It should be recognized that the particular material of the strips and the adhesive utilized are not critical aspects of the invention. Any materials commonly utilized in the art of cellular structures suitable for window coverings may be used. For example, the material for the rows may be fabric, paper, film, laminate, or the like.

In this embodiment the construction of the preform 28 is part of the overall process. However, it should be appreciated that the preform can be formed in a separate process and on a separate apparatus.

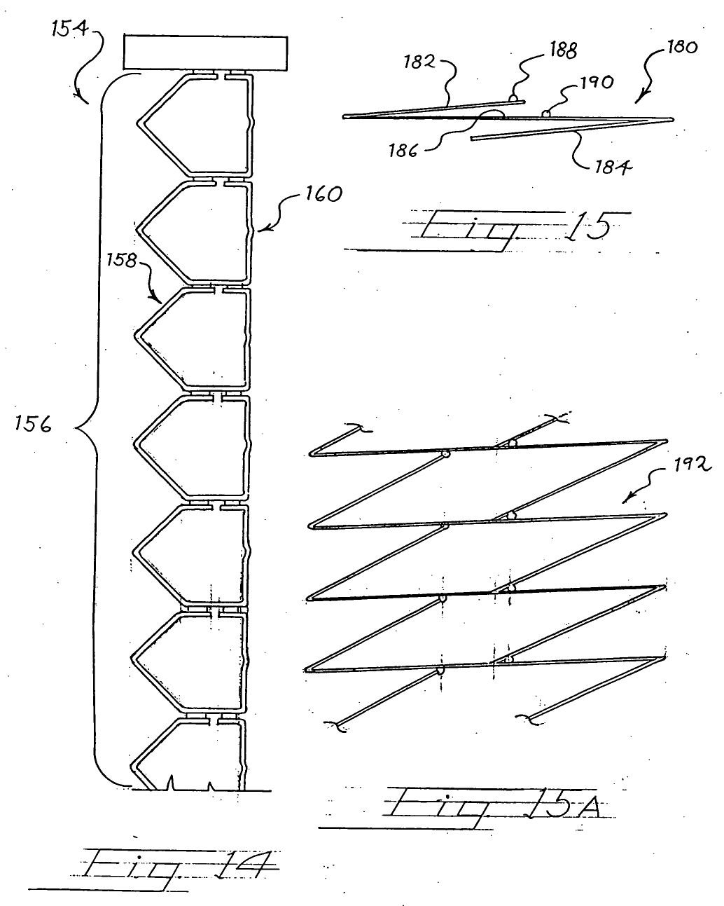

Another embodiment of the present invention is shown in FIGS. 8-14. The apparatus and process depicted is similar to the previous embodiment. Referring to FIG. 8, a continuous ribbon of material 110 on roll 112 is conveyed by a drive (not shown) and a series of feed rollers 116 downstream to a folder 118. The material 110 is again folded by the progression of the material 110 through the folder 118 to form a preform. In this embodiment, the folder 118 is configured to create a somewhat different preform than in the previous embodiment. As shown in FIGS. 9 and 10, the material 110 is folded as it passes through channel 122 of folder 118. The material is folded such that two marginal portions 124 and 125 and a central portion 126 are formed. Marginal portion 124 is narrower than marginal portion 125 such that the preform 128 has an asymmetrical transverse cross section as shown in FIG. 11. The preform 128 again continues downstream to an adhesive applicator 140. Similar to the process discussed in the previous embodiment, the application of adhesive is halted after a predetermined length of material is processed and the conveyance of the preform is also stopped such that a transverse region substantially free of adhesive is created. The cutter then cuts the preform at the transverse region. Since the folding pattern of the present embodiment is somewhat different than the previous embodiment, the adhesive lines 142 are set down as shown in FIG. 12.

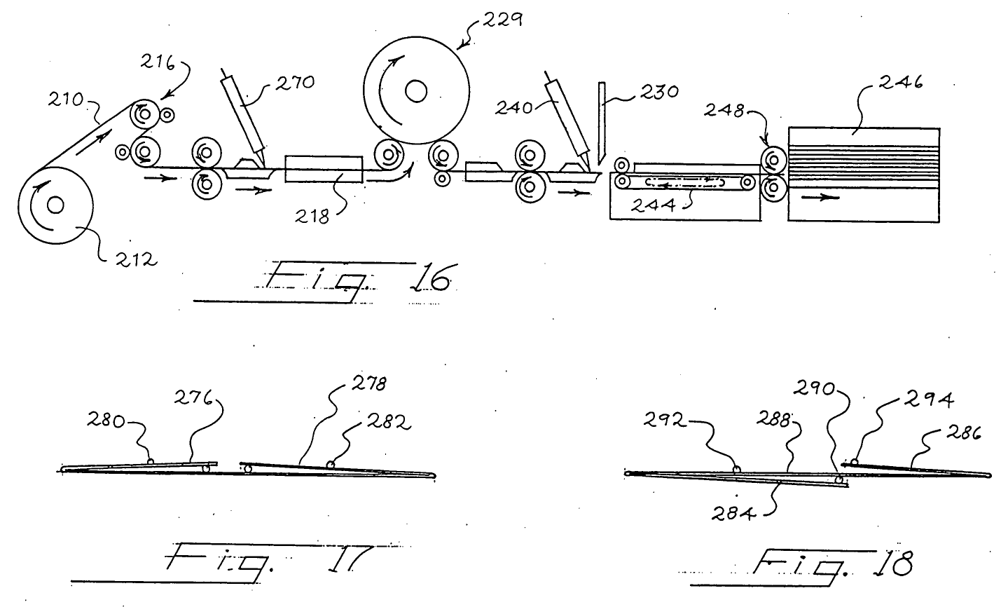

As with the previous embodiment, the row member 138 is transported downstream by conveyor belt 144 supporting the row member to stacker 146. As the row member 138 approaches stacker 146, an airflow device, such as blower 148 accelerates the downstream conveyance of the row member 138 into the stacker 146. Referring to FIG. 13, the row member 138 is supported within the stacker on lift member 150, which raises the row member 138 into contact with other row members 152 and bonds row member 138 thereto. A window covering 154 including the cellular structure 156 formed as described is shown in FIG. 14. As shown, when expanded, the cellular structure 156 forms a single column of cells, each cell having a pleated face 158 and a substantially flat rear 160. The rear 160 also acts as a limiting member which restricts the amount the cells and overall window covering may be expanded.

With each of the previous embodiments, a preform that forms a complete tube is described. Other folding patterns may also be utilized. For example, referring to FIG. 15, a non-tubular folding pattern is shown. Preform 180 is formed from marginal portions 182 and 184, which are overlapped with central portion 186. Adhesive lines 188 and 190 are placed by the adhesive applicator. When stacked, the preform 180 cooperates with similarly constructed preforms to form a cellular structure 192 such as shown in FIG. 15A.

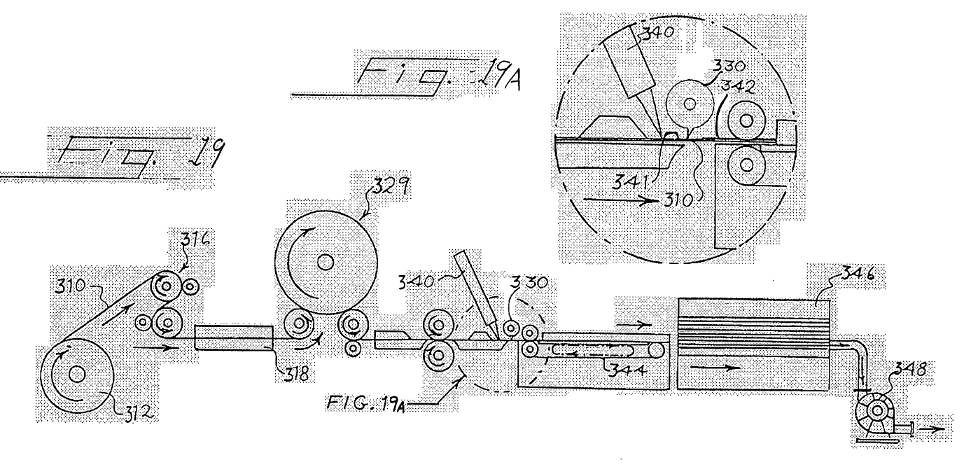

Another embodiment of a process and apparatus according to the present invention, is shown in FIGS. 16-18. In many respects, this embodiment is like that shown in FIGS. 1-6.

Referring to FIG. 16, as before, a continuous ribbon of material 210 is conveyed by a drive mechanism (not shown) from a roll 212 by way of a series of feed rollers 216 downstream to a folder 218. The material 210 is folded to form a preform, which is conveyed by another series of heating rollers 229 downstream. In this alternative embodiment, an additional adhesive applicator 270 is provided that places at least one line of adhesive on the material 210 before it enters the folder 218. For example, as shown in FIG. 17, adhesive lines 272 are placed on a central portion 274. Marginal portions 276 and 278 are folded over central portion 274 and adhered thereto by adhesive lines 272. Another example of such a folding pattern is shown in FIG. 18. In this example marginal portion 284 and marginal portion 286 are folded over opposite surfaces of central portion 288. Only adhesive line 290 is applied by adhesive applicator 270. Adhesive lines 292 and 294 are applied by applicator 240. With each of these folding patterns, double cell rows are formed when stacked.

The material, as discussed above, is then transported downstream to adhesive applicator 240 and cutter 230. Rollers 229 may partially dry or cure the adhesive applied by adhesive applicator 270. As before, the progression of the preform is halted after actuating the cutter 230 to form a row member. The row member is transported downstream to stacker 246 by conveyor belt 244. In this embodiment, a pair of rollers 248 are used to accelerate the row member into the stacker 246, which stacks the row member with similarly formed row members. Preferably, such a set of rollers would be split rollers to avoid contact with the adhesive lines.

Yet another embodiment of the present invention is shown with respect to FIGS. 19 and 19A. Similar to the previous embodiments, a continuous ribbon of material 310 is conveyed by a drive mechanism (not shown) from a roll 312 by way of a series of feed rollers 316 downstream to a folder 318. The material 310 is folded to form a preform, which is conveyed by another series of heating rollers 329 downstream. The material 310 is transported downstream to adhesive applicator 340 and cutter 330. Unlike in the previous embodiments, the progression of the preform is not halted. Instead, the application of adhesive by the adhesive applicator 340 operates in a stop-and-go manner. As the preform is guided past the adhesive applicator 340, a line of adhesive is applied to a predetermined length. The application of adhesive is then stopped briefly while the preform continues downstream. Accordingly, a transverse region 341 is formed that is substantially free of adhesive. The cutter 330 severs the preform at this transverse region 341. It is preferred that the cutter 330 take the form of a roller blade that is synchronized to contact the material at the transverse region 341. The row member is transported downstream to stacker 346 by conveyor belt 344. In this embodiment, a vacuum 348 is used to accelerate the row member into the stacker 346, which stacks the row member with similarly formed row members.

The foregoing descriptions are to be taken as illustrative, but not limiting. Still other variants within the spirit and scope of the present invention will readily present themselves to those skilled in the art.

What is claimed is:

1. A method for making an expandable honeycomb structure suitable for a window covering, the method comprising:
(a) providing a continuous preform defining at least at least one marginal portion and a main portion where the marginal portion is overlapped with the main portion;
(b) conveying the preform to an adhesive applicator and applying at least one line of adhesive to the preform with the adhesive applicator;
(c) conveying the preform including adhesive past a cutter,
(d) ceasing application of the adhesive to the preform and defining a transverse region of the preform that is substantially free of adhesive;
(e) conveying the transverse region of the preform into alignment with the cutter;
(f) the cutter cutting the preform to define a row member;
(g) conveying the row member downstream towards a stacker; and
(h) receiving the row member in the stacker, wherein the stacker stacks and bonds the row member with other row members, and resets to receive an additional row member.

2. The method of claim 1 wherein conveyance of the preform is intermittent such that conveyance of the preform is ceased after conveying the transverse region of the preform into alignment with the cutter and is resumed after cutting the preform to define the row member.

3. The method of claim 1 wherein conveyance of the preform to form the additional row member is resumed after an adequate time gap is created such that the additional row member is received in the stacker after the stacker resets.

4. The method of claim 1 wherein conveying the row member downstream further includes increasing the downstream progression of the row member towards the stacker.

5. The method of claim 4 wherein an airflow device increases the downstream progression of the row member towards the stacker.

6. The method of claim 4 wherein a roller increases the downstream progression of the row member towards the stacker.

7. The method of claim 1 wherein providing the continuous preform further comprises conveying a continuous ribbon of material to a folder, wherein the folder folds the continuous ribbon of material to form the preform.

8. The method of claim 7 further comprising applying at least one line of adhesive to the preform and securing the at least one marginal portion to the main portion.

9. An apparatus for making an expandable honeycomb structure suitable for a window covering, the apparatus comprising:
a conveyor for transporting a continuous preform defining at least one marginal portion and a main portion where the marginal portion is overlapped with the main portion to an adhesive applicator;
the adhesive applicator for applying a predetermined length of at least one line of adhesive to the preform;
the conveyor forming a transverse region substantially free of adhesive after the adhesive applicator applies the predetermined length of adhesive to the preform;
a cutter for cutting the preform at the transverse region to define a row member;
a transporter for moving the row member towards a stacker; and
the stacker suitable for receiving the row member and stacking and bonding the row member with other similarly formed row members, the stacker resetting after stacking the row member to receive an additional row member.

10. The apparatus of claim 9, wherein the conveyor is suitable for operating in an intermittent manner.

11. The apparatus of claim 9 further comprising an accelerator for increasing the downstream progression of the row member towards the stacker.

12. The apparatus of claim 11, wherein the accelerator is an airflow device.

13. The apparatus of claim 1, wherein the accelerator is a roller.

14. The apparatus of claim 9 further comprising a roll of material that is conveyed to a folder for forming the preform.

15. The apparatus of claim 9 further comprising a second adhesive applicator for applying at least one line of adhesive to the material and a folder for folding the material to form a preform by at least securing one marginal portion to the main portion.

16. A method for making an expandable honeycomb panel comprising a plurality of row members, the method comprising:
supplying a folded preform having a least one marginal portion folded with a main portion;
forming a row member by conveying the preform by an adhesive applicator and actuating the applicator to deposit at least one line of adhesive on the preform, conveying the preform with the adhesive past a cutter, discontinuing operation of the adhesive applicator after a desired length of the preform with the adhesive is transported downstream of the cutter and forming a transverse region of the preform that is substantially free of adhesive, and actuating the cutter to sever the transverse region of the preform;
(c) conveying the row member to a stacker;
(d) stacking the row member with similarly formed row members; and
(e) creating a gap after forming the row member, thereafter forming a subsequent row member by repeating steps (b), (c) and (d).

17. The method of claim 16 wherein creating the gap includes accelerating the row member to the stacker.

18. The method of claim 16 wherein creating the gap includes ceasing conveyance of the preform prior to cutting and resuming conveying the preform after stacking the row member and resetting the stacker to receive the subsequent row member.

19. The method of claim 16 wherein supplying the continuous preform further comprises conveying a continuous ribbon of material to a folder, wherein the folder folds the continuous ribbon of material to form the preform.

20. The method of claim 19 further comprising applying at least one line of adhesive to the preform and securing the at least one marginal portion to the main portion.
